(19) United States
(12) Patent Application Publication
(10) Pub. No.: US 2006/0031696 A1
(43) Pub. Date: Feb. 9, 2006

(54) Method and apparatus for determining time

(76) Inventors: Thomas Michael King, Tempe, AZ (US); David Kevin FitzRandolph, Phoenix, AZ (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/894,840

(22) Filed: Jul. 20, 2004

(51) Int. Cl. H04L 7/00

(52) U.S. Cl. 713/400

(57) ABSTRACT

An apparatus (200) for determining time within a global navigation satellite receiver comprises a correlator (1), a combiner (35, 37), a comparator, and a processor. The correlator (1) comprises a means for determining a common data pattern between received signals of at least two satellites, and a means for calculating a dot product (15) for each of the at least two received signals. The combiner (35, 37) combines the calculated dot products to generate a combined dot product result. The comparator (41, 43) compares the combined dot product results with the common data pattern to generate a comparing result. The processor (47) determines a time from the comparing result.

### BACKGROUND OF THE INVENTION

1. Field of the Invention

The present invention is generally related to wireless communication systems and in particular to wireless communication systems including global positioning systems.

2. Description of the Related Art

Wireless communication positions today are taking advantage of the additional capabilities when linking with GPS (Global Positioning System). The Global Positioning System (GPS) is a worldwide radio-navigation system formed from a constellation of twenty four (24) satellites and their ground stations. GPS uses these “man-made stars” as reference points to calculate positions accurate to a matter of meters. A GPS receiver uses the satellites in space as reference points for locations here on earth. The GPS receiver measures distance using the travel time of radio signals. The GPS receiver has very accurate timing to measure travel time. Along with distance, the GPS receiver knows exactly where the satellites are in space. Finally, the GPS receiver corrects for any delays the signal experiences as it travels through the atmosphere.

In some wireless communication systems, such as those operating using CDMA (Code Division Multiple Access), the infrastructure is synchronized in time by way of GPS. Every base station has precise time available from a local GPS receiver and synchronizes the base station transmissions relative to absolute time. The wireless communication device then synchronizes to the base station transmissions which allows precise time transfer from the base station to the wireless communication device to an accuracy on the order of one (1) microsecond plus the time of the transmission delay from the base station to the wireless communication device (on the order of zero to tens of microseconds depending on the distance between the base station and wireless communication device).

With a synchronized scheme in which the wireless communication device has absolute time available to an accuracy well below one (1) millisecond, it is possible to use this time for such purposes as (a) acquisition assistance, (b) determination of time of GPS measurements, and (c) avoidance of decoding the time information directly from the GPS broadcast message.

A number of schemes have been developed or proposed for delivering precise time information to non-synchronized wireless communication devices for purposes of position location by way of GPS. Drawbacks of these current schemes include requiring a large number of bits be transmitted from mobile to base or base to mobile in order to work, requiring another element in a communications network thereby adding cost, and/or requiring large bandwidth and/or memory allocations.

### BRIEF DESCRIPTION OF THE DRAWINGS

The accompanying figures, where like reference numerals refer to identical or functionally similar elements throughout the separate views and which together with the detailed description below, are incorporated in and form part of the specification, serve to further illustrate various embodiments and to explain various principles and advantages all in accordance with the present invention.

FIG. 1 illustrates a satellite broadcast data message.

FIG. 2 is a block diagram illustrating top-level processing stages for determining time.

FIGS. 3, 5, and 6 are flowcharts illustrating various portions of a method of determining time using the block diagram of FIG. 2.

FIG. 4 illustrates a sequence of dot products for use within the processing and method of FIGS. 2 and 3.

FIG. 7 is a graph illustrating test results of the performance of the method described in FIGS. 2 through 6.

FIG. 8 is a block diagram of an alternate embodiment for top-level processing stages for determining time.

### DETAILED DESCRIPTION

The present invention relates to determining time for a wireless assisted GPS (Global Positioning System) solution in a non-synchronized wireless communication device (example, Global System for Mobile Communications (GSM)). The present invention provides a method and apparatus for delivering precise time information to non-synchronized wireless communication devices for purposes of position location by way of GPS.

This time information can then be utilized by the wireless communication device for acquisition assistance. Knowledge of absolute time in the handset allows the mobile to reduce the GPS code phase search space in order to acquire the GPS signal, greatly reducing the time to acquire the signal.

This time information can further be utilized by the wireless communication device for determination of time of GPS measurements. The time of the measurement is important because the satellite signals (and therefore the measured range to the satellites) changes at a rate up to 4 meters per millisecond. If the time of the measurement of the ranges is known to an accuracy of, say, 20 milliseconds, then the range error can be as great as 80 meters to each satellite which will directly translate into additional position error.

Further, this time information can be utilized to avoid decoding the time information directly from the GPS broadcast message. A traditional GPS sensor determines local time by demodulating the 50 BPS (bits per second) broadcast message from the satellites. In some cases, the signal is weak (in buildings, under trees, urban canyons) and therefore the receiver is unable to decode the 50 BPS message directly. In addition, the system must wait until the GPS time information bits (handover (HOW) word) are delivered by the satellites, which repeats every six seconds. Setting time through some other method avoids having to wait for these time information bits.

The present invention uses the fact that the entire GPS satellite message structure is predictable with time. There are at least three segments of the satellite broadcast data (each of which repeat every 6 seconds) in which the 50 BPS data pattern is known. These known and predictable data patterns can be used to determine precise time in the handset without having to transmit the 50 BPS message structure from some base reference to the mobile, for cases in which the signal is too weak to demodulate the individual data bits directly.

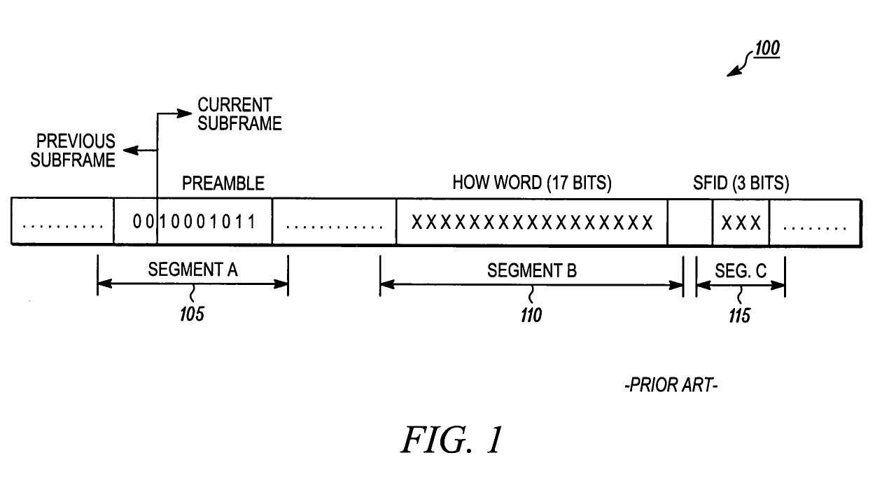

FIG. 1 illustrates a satellite broadcast data message 100. The satellite broadcast data message 100 includes three data segments (105, 110, and 115) that are either known or are predictable with time. Segment A (105) is the well-known message preamble, always 0010001011. Typically, the 0010001011 pattern consists of two bits from the previous subframe (i.e., the first two bits; “0”), and the eight-bit message preamble “10001011”, which repeats on 6-second epochs. The 8-bit preamble begins in time at T=N*6.000000000 seconds into the week. The 10-bit concatenation sequence 0010001011 then begins at time T=(N*6.000000000)−0.040 seconds into the week, where N represents an integer.

Both Segment B (110) and Segment C (115) are contained within the HOW word. Segment B (110) is the 17-bit TOW (time of week) field which represents GPS time at the start of the next subframe. Segment C (115) is the SFID (subframe identification) represents one of five possible subframe ID's (identifications). The GPS data stream is grouped into 30-second frames, each frame having 5 subframes in it. The SFID field (115) allows the receiver to determine which of those 5 subframes the current subframe resides. Both TOW (110) and SFID (115) are deterministic as a function of approximate time. For example, if time is known to within 3 seconds, then TOW (110) and SFID (115) are deterministic. If time is known to 6 seconds, then one of two possible TOW/SFID patterns are possible and so forth.

Due to the 6-second periodic nature of the 10-bit preamble and time being known as T=(N*6.000000000)−0.040 with each reception event, the reception time of the preamble coupled with an initial time accuracy of ±3 seconds allows for ambiguity resolution of time and direct determination of N. In addition, it is possible to extend the ambiguity resolution time period beyond the ±3 second level by taking advantage of a minimum residuals test if 4 or more satellites are detected. For example, if time is known to an accuracy of 30 seconds, then all possible N's can be tested that cover the 30-second time uncertainty range, selecting the correct N that minimizes the residuals. These two methods have previously been disclosed in co-pending U.S. patent application US20030187575A1 to King, Et. al., assigned to Motorola, Inc. and entitled “Time Determination In Satellite Positioning System Receivers And Methods Therefore.”

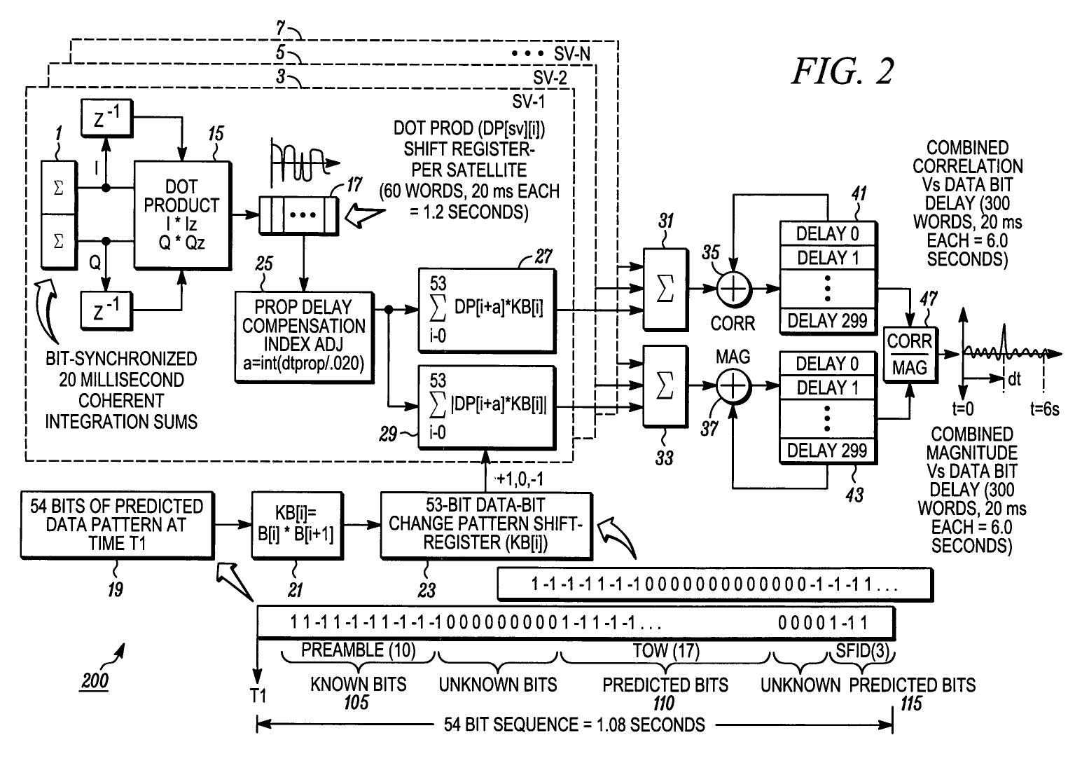

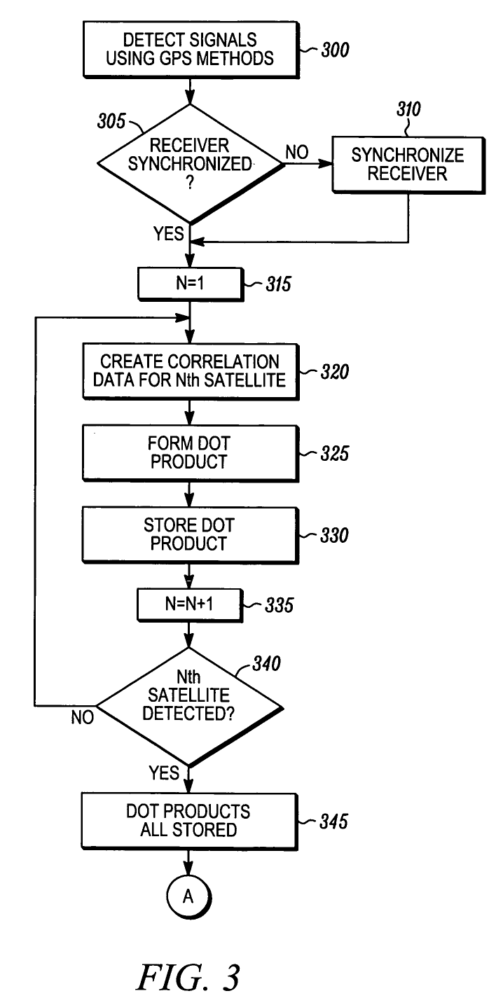

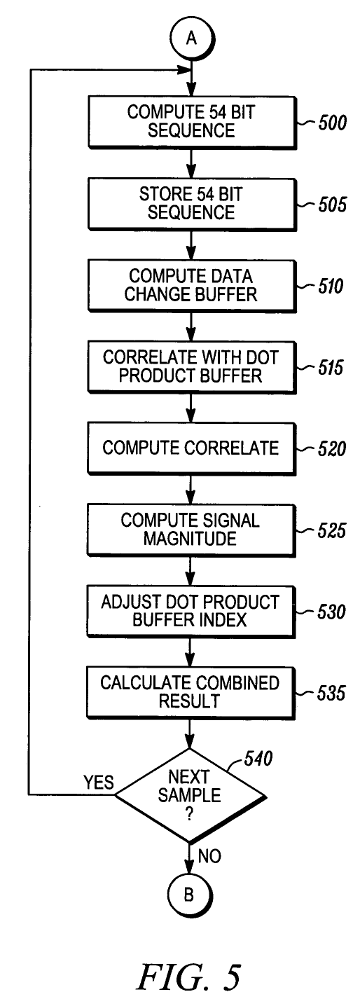

FIG. 2 is a block diagram illustrating the top-level processing stages of determining time using the present invention. For clarification, the process of FIG. 2 is further illustrated and described in the flowcharts of FIG. 3 and 5. In the following description, the process is described using the flowchart of FIGS. 3 and 5 while referring to the elements of FIG. 2.

FIG. 3 is a flowchart illustrating the process for determining and storing dot products corresponding to detected satellites. As illustrated, the process begins with Step 300 in which multiple signals in weak signal conditions are detected using assisted GPS methods as is known in the art. (See, for example, U.S. Pat. Nos. 6,532,251 and 6,346,911). Next, in Step 305, the process checks that the receiver has synchronized to the 50 BPS data message embedded on the signal using methods as are well known in the art. (Such as the method as described in U.S. Pat. No. 6,532,251, in which the data bit edge timing, is easily detectable below −150 dBm.) When the receiver has not synchronized, the process continues to Step 310 in which the receiver is synchronized. Next, and when the receiver has been synchronized in Step 305, the process continues to Step 315 in which a counter is set to N=1. Next, in Step 320, an Nth sequence of 20 millisecond coherent In-phase and Quadrature correlation data is created by the correlator for the Nth satellite [1], each sample separated in time from the previous by 20 milliseconds. It is possible to use other time periods for the In-phase and Quadrature samples, for example, 10 milliseconds can be used. Any time period that is evenly divisible into the 20-millisecond data period can be used, 20 milliseconds being most optimum as having the most coherent integration gain. Next, in Step 325, a dot-product [15] is formed for each new 20-millisecond sample. Next, in Step 330, the dot product is stored in a shift register or circular buffer [17], one circular buffer [17] for each of the N satellites. Next, in Step 335, the counter is incremented. Next, in Step 340, the processor determines whether the Nth satellite has been processed. When the Nth satellite has been detected, the process cycles to Step 345, otherwise it cycles back to Step 320. In this method, each satellite detected, sv1 [3], sv2 [5], sv-n [7], up to 12 total, is processed in the same way, producing twelve sets of in-phase and quadrature data [1] at the 20-millisecond rate. In this manner, a dot-product [15] is formed for each new 20-millisecond sample, producing a sequence of dot-products that are then stored in a shift-register or circular buffer [17]. To cover a test-sample length including the preamble, TOW, and SFID, a total length of 60 words are required in the shift-register memory [17], each word corresponding in time to one data bit time (20 milliseconds). When the Nth Satellite has been detected in Step 340, the process ends at Step 345 with all dot products being stored. (node A)

Shift register [17] of FIG. 2 contains the last 60 dot products covering the last 1.2 seconds of data, one shift register [17] assigned to each of the N satellites. The dot-product is useful to detect the ±180 degree phase transitions due to the 50 BPS data modulation on the bi-phase modulated GPS signal. The dot product forms the product DP=I*Iz−Q*Qz, where the z-subscript denotes a 20 millisecond-delayed version of the corresponding sample.

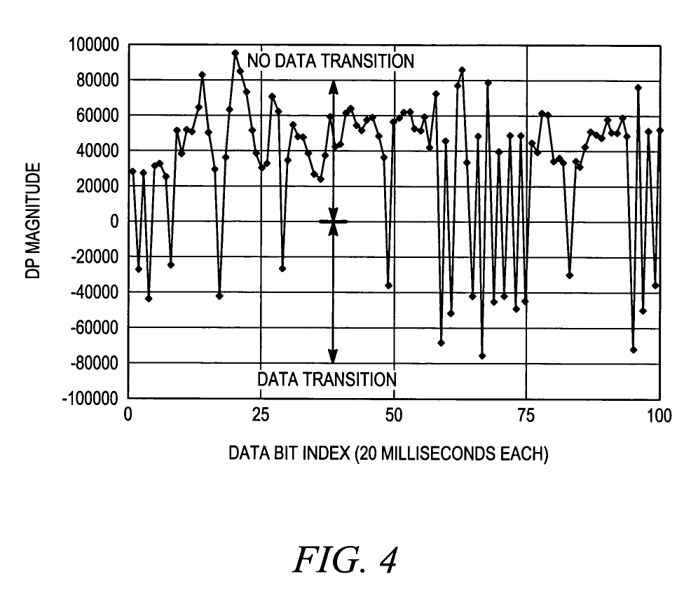

FIG. 4 illustrates a corresponding sequence of the dot product, when the DP parameter is above zero denotes no data bit change (i.e., the lack of a + or −180 degree phase rotation detected within the 40 millisecond period demarked by the I/Q and Iz/Qz samples) while when the DP parameter is below zero indicates a 50 BPS data transition (i.e., a + or −180 degree phase rotation detected within the 40 millisecond period demarked by the I/Q and Iz/Qz samples). FIG. 4 was recorded with a relatively strong signal in which individual 50 BPS data bit transitions are very visible and detectable. With weak signals, it is not possible to visualize the data pattern, but the corresponding dot-product does still carry the data change information that can be extracted by correlation against the known pattern.

Referring to the flowchart of FIG. 5 (with block diagram references to FIG. 2), the process begins with Step 500 (node A) in which, based on an estimated time, a predicted 54 bit sequence is computed having a 10 bit preamble, a 17 bit TOW, and a 3 bit SFID embedded in the 54 bit segment. Next, in Step 505, this 54 bit predicted sequence is then stored in the buffer [19]. Known bits have polarity of either +1 or −1, while unknown bits have a magnitude of zero. The 54-bit predicted sequence applies to all satellites given that each satellite transmits the same pattern for the preamble, TOW, and SFID simultaneously. As such, the single buffer [19] is used to develop a test pattern where the beginning of the known sequence is known to start at T=(N*6.00000000)−0.040 seconds since the start of the week, the only difference between each satellite received sequence is the 60-90 millisecond propagation time from satellite to the ground-based user which is highly predictable based on approximate knowledge of user location. Note that the 40 millisecond offset in time represents the time of arrival of the 1^{st} bit of the 10-bit preamble sequence, the first two bits representing the last two bits of the previous subframe. Given an approximate time better than 3 seconds, the ambiguity of the N is solved, thus measuring the time of arrival of the predicted bits sequence allows for near-perfect time determination.

Next, in Step 510, the known 50 BPS sequence [19] is used to compute a predicted “data-change” buffer [23], which has a magnitude of −1 when a predicted data bit change occurs, magnitude of +1 when no data bit change occurs, and magnitude zero when an unknown state occurs. The predicted bit sequence [19] can be described as a buffer B[i], where the index “i” runs from zero to 53. The data change buffer KB[i] is then computed as KB[i]=B[i]*B[i+1] as shown in [21].

Next, in Step 515, the resulting data change buffer [23] then is used to correlate against each satellite's Dot-Product buffer [17] (see FIG. 3) in order to search for the known bits pattern embedded in the dot-product buffer. For each 20-millisecond sample of I and Q data, each satellite dot-product buffer [17] is individually correlated against the known data change buffer [23] for the full 1.2 seconds of the dot-product buffer.

Next, in Step 520, correlator [27] sums the product of the dot product buffer [17] with the predicted data change buffer [23] to compute a correlate representing the likeness of the dot product buffer to the predicted data change buffer.

Next, in Step 525, a signal magnitude sum [29] is also computed to be used later in normalization of the results. Since each satellite broadcasts the identical predicted bits data pattern simultaneously, the ground receiver will receive the pattern at different times only dependent on geometry and individual satellite clock error. Thus, additional signal processing gain can be achieved by compensating each satellite for the predictable propagation delay plus satellite clock error and further summing all satellites correlated data into a single result.

Next, in Step 530, block [25] adjusts the dot product buffer index when data is read out by an amount proportional to the predicted dt-propagation delay plus satellite clock error. Since the data stored in the buffer is in integer 20 millisecond blocks (data has already been adjusted by bit-sync timing), only an integer offset in the dot product buffer is needed. As such, in Step 535, the individual satellite correlation results are all summed together in block [31] and [33], the final sum [35] and [37] represent the correlated combined result for one possible delay corresponding to the data pattern presently in the dot product buffers [17]. For example, the 1st combined outputs [35], [37] are summed into the delay-0 correlation RAM [41] and [43] and the last combined outputs [35], [37] are summed into delay-299 correlation RAM [41] and [43].

In Step 540, the process determines whether or not a next sample is available. When the next 20 millisecond I and Q sample is available from the coherent correlator, the process repeats, and a new dot product sample is inserted into the dot product shift-register [17]. All samples move one place in the dot-product buffers. The correlation process repeats, multiplying the shifted dot-product buffers (adjusted for prop delay), by the predicted data change buffer [23]. The next sum [35], [37] are the summed into the delay-1 combined correlation RAM [41], 43]. The process continues for the full six seconds of the repeat pattern of the predicted bits sequence of data, filling up all 300 words of the combined correlation RAM [41], [43]. When no next sample is available, the correlation portion of the process ends. (node B)

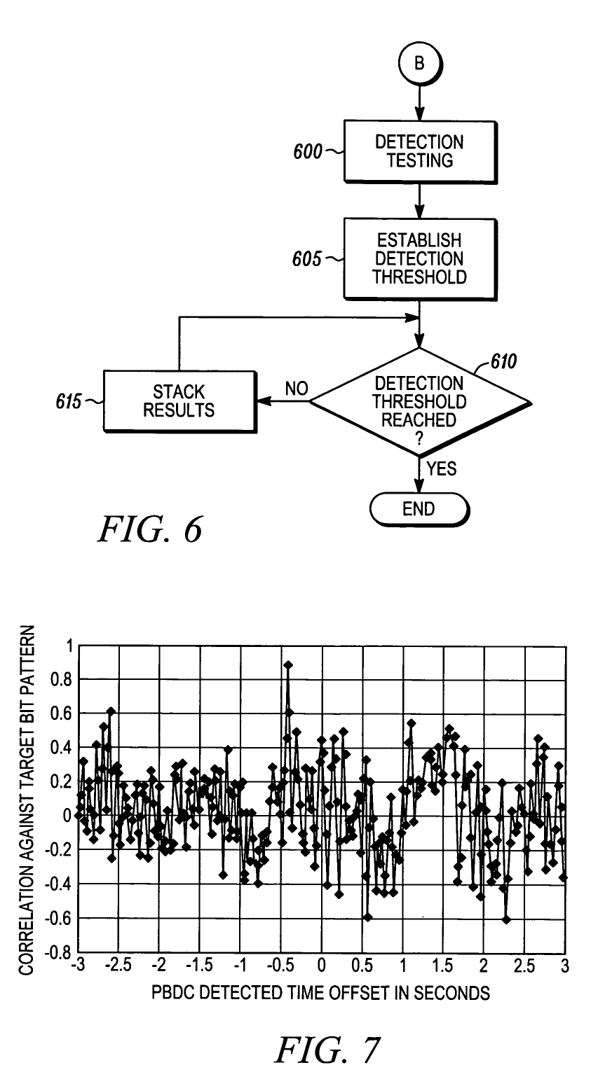

Referring to the flowchart of FIG. 6 (with block diagram references to FIG. 2), the process begins with Step 600 (node B) in which detection tests are completed on the normalized combined outputs by dividing the correlation output from RAM [41] by the magnitude output in RAM [43] in block [47]. Next, in Step 605, a peak signal to noise threshold is used on the output of the quotient to establish the detection threshold, the delay bin number in RAM corresponding to the peak signal represents the time delay in 20 millisecond increments of the reception of the predicted bits sequence corresponding in time to T=(N*6.000000000)−0.040 seconds since the start of the week. Perfect correlation corresponds to a quotient of +1.

Next, in Step 610, the process determines whether or not a detection threshold is reached in 6 seconds. If no detection threshold is reached after 6 seconds, then the process continues until positive detection occurs, effectively stacking (adding) subsequent 6-second intervals of data in RAM's [41] and [43]. Delay [0] is updated at time=0, 6.0, 12.0, 18.0 seconds since the start of the process. Delay[1] is updated at time=0.020, 6.020, 12.020, 18.020 seconds since the start of the process, and so forth through Delay[299], which is updated at time=5.980, 11.980, 17.980 seconds since the start of the process and so forth. In step 615, the next six seconds of data is summed on top of the previous data stored in RAM 41 and 43, stacking results over multiple six-second intervals producing additional signal processing gain. The process then cycles back to Step 610 until detection occurs. Once detection occurs, the process ends.

FIG. 7 shows the performance of the method as described previously herein. Eight satellites all at −153 dBm were processed, resulting in positive detection of the predicted bits sequence at a time offset of approximately −0.420 seconds. Signal processing gain occurs in the satellite-dimension as N-satellites of identical data (i.e., data matching the predicted identical data) are summed. In addition, signal processing gain occurs in the time dimension, as multiple occurrences of the 6-second sequence are stacked on top of each other. Stacking of like-data frames of GPS data to create signal processing gain has previously been described in U.S. Pat. No. 5,768,319. Stacking of identical GPS data in the satellite dimension has not previously been disclosed.

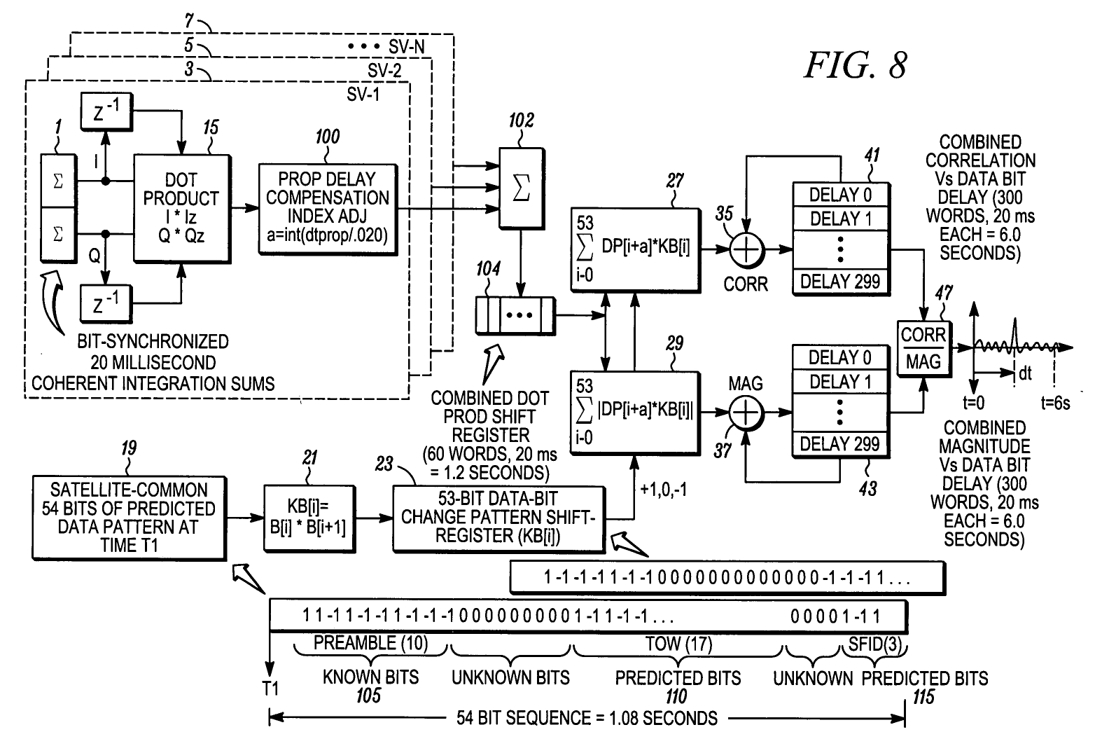

FIG. 8 is an electronic block diagram of an alternate embodiment of the invention that takes further advantage of the fact that the predicted bits sequence we are searching for is always a common data pattern among all received satellites, for example, the data elements in FIG. 1. In FIG. 8, each satellite produces a dot-product sequence as before. Each satellite's dot-product sequence is then delayed according to the estimated satellite to user delay plus satellite clock error delay in block [100]. The dot-products are then combined by adder [102] into ONE dot-product shift register [104] by simply adding together all delayed data from each satellite. Alternately, the data can be weighted based on received signal power or C/No, but since the dot-product magnitudes are proportional to signal power, this naturally occurs without additional specific weighting. The combined dot-product shift register [104] is then correlated with the predicted data-change pattern for up to six seconds of time, the remaining back-end processing remaining the same as discussed in FIGS. 2 through 6. The method of FIG. 8 requires only one dot-product shift register. It takes advantage of the fact that we are always looking for a common data pattern among all received satellites, thus adding or stacking the dot-product results from each satellite into one common combined dot-product shift register produces higher signal to noise ratio on the data contained in the combined dot product shift register allowing the correlation function to converge more rapidly and indicate a peak threshold detection. The satellite-dimension stacked data cancels when the data pattern is different across the multiple satellites and increases when the data pattern across multiple satellites is the same.

The present invention provides an apparatus and method for transforming the correlation data into a form that can be combined across multiple satellites and naturally provides signal processing gain when the data patterns received are identical. It further provides for a normalized threshold that combines data from multiple satellites automatically normalizes and weights the stronger satellites based on signal power, de-weighting the weaker satellites in the solution. With the present invention, coherent correlation draw-backs of very narrow frequency response and dependence on stable reference oscillators during the correlation are greatly reduced. This is done through the use of data bit polarity changes, instead of the actual data bits themselves. Recognizing that the data pattern searched for is common between all satellites, combining the multiple satellite dot product results before correlation occurs increases SNR (signal to noise ratio) and allows for more rapid detection.

The present invention allows for determination of time to sufficient accuracy for a GPS receiver contained in GSM or other non-synchronized handset. It does so without requiring that the GSM network be synchronized with LMU's (location measurement units). It does so without requiring data bits to be transmitted from the GSM network specific to setting time. It provides for the utilization of existing over the air protocol is sufficient.

While this disclosure includes what are considered presently to be the preferred embodiments and best modes of the invention described in a manner that establishes possession thereof by the inventors and that enables those of ordinary skill in the art to make and use the invention, it will be understood and appreciated that there are many equivalents to the preferred embodiments disclosed herein and that modifications and variations may be made without departing from the scope and spirit of the invention, which are to be limited not by the preferred embodiments but by the appended claims, including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, will be limited in the interest of brevity and minimization of any risk of obscuring the principles and concepts according to the present invention.

We claim:

1. A method for determining time comprising the steps of:
determining a common data pattern between at least two received signals;
calculating a dot product for each of the at least two received signals;
comparing the dot products of the at least two received signals with the common data pattern to generate at least two comparing results;
combining the comparing results; and
determining a time from the combined comparing result.

2. A method as recited in claim 1, further comprising, prior to the determining step, the step of:
receiving a signal from each of at least two global navigation satellites.

3. A method as recited in claim 1 wherein the calculating dot products step comprises for each of the at least two received signals:
creating a coherent in-phase and quadrature correlation data; and
forming a sample the dot product from the correlation data.

4. A method as recited in claim 1 further comprising, prior to the combining step, the step of:
storing the calculated dot product for each of the at least two received signals in separate dot product buffers.

5. A method as recited in claim 4, further comprising the steps of:
correlating the calculated dot product for each of the at least two received signals with a data change buffer.

6. A method as recited in claim 5 wherein the data change buffer comprises the result of the steps of:
computing a predicted sequence based on an estimated time;
storing the predicted sequence;
calculating a predicted data change using the predicted sequence; and
storing the predicted data change in the data change buffer.

7. A method as recited in claim 6 wherein the correlating step comprises:
multiplying and accumulating each dot product with the predicted data change buffer to compute a correlate representing the likeness of the dot product buffer to the predicted data change buffer.

8. A method as recited in claim 7 further comprising the step of:
computing a signal magnitude sum.

9. A method as recited in claim 7, wherein the combining step comprises:
summing together the individual satellite correlation results.

10. A method as recited in claim 1, further comprising the steps of:
delaying each satellite's dot product sequence according to an estimated satellite to user delay plus satellite clock error delay.

11. An apparatus for determining time within a wireless communication device comprising:
a correlator comprising:
means for determining a common data pattern between at least two received signals, and
means for calculating a dot product for each of the at least two received signals;
a comparator coupled to the correlator for comparing the combined dot product results with the common data pattern to generate at least two comparing results;
a combiner coupled to the comparator for combining the at least two comparing results to generate a combined comparing result; and
a processor coupled to the combiner for determining a time from the combined comparing result.

12. An apparatus as recited in claim 11, further comprising;
a receiver coupled to the correlator for receiving a signal from each of at least two global navigation satellites.

13. An apparatus as recited in claim 11 wherein the correlator further comprises:
means for creating a coherent in-phase and quadrature correlation data; and
means for forming a sample dot product from the correlation data.

14. An apparatus as recited in claim 11 further comprising;
at least two dot product buffers coupled to the correlator for storing the calculated dot product for each of the at least two received signals.

15. An apparatus as recited in claim 14, further comprising:
a data change buffer for storing a data change; and
a second correlator coupled between the data change buffer and the at least two dot product buffers for correlating the calculated dot product for each of the at least two received signals with the data change.

16. A method for determining time comprising the steps of:
determining a common data pattern between at least two received signals;
calculating a dot product for each of the at least two received signals;
combining the calculated dot products to generate a combined dot product result;
comparing the combined dot product results with the common data pattern to generate a comparing result; and
determining a time from the comparing result.

17. A method as recited in claim 16, further comprising, prior to the determining step, the step of:
receiving a signal from each of at least two global navigation satellites.

18. A method as recited in claim 16 wherein the calculating step comprises for each of the at least two received signals:
creating a coherent in-phase and quadrature correlation data; and
forming a sample of the dot product from the correlation data.

19. A method as recited in claim 16 wherein the combining step further comprises the step of:
summing the calculated dot products for each of the at least two received signals into a combined dot product buffer.

20. A method as recited in claim 19, further comprising, after the combining step, the step of:
correlating the combined dot product with a data change buffer.

21. A method as recited in claim 20, further comprising, prior to the correlating step, the steps of:
computing a predicted sequence based on an estimated time;
storing the predicted sequence;
calculating a predicted data change using the predicted sequence; and
storing the predicted data change in the data change buffer.

22. A method as recited in claim 20, wherein the correlating step comprises:
multiplying and accumulating the combined dot product with the predicted data change buffer to compute a correlate representing the likeness of the combined dot product buffer to the predicted data change buffer.

23. A method as recited in claim 22 further comprising the step of:
computing a signal magnitude sum.

24. A method as recited in claim 16, further comprising the step of:
delaying each dot product according to an estimated satellite to user delay plus a satellite clock error delay.

25. An apparatus for determining time within a wireless communication device comprising:
a correlator comprising:
means for determining a common data pattern between at least two received signals, and
means for calculating a dot product for each of the at least two received signals;
a combining means coupled to the correlator for combining the calculated dot products to generate a combined dot product result;
a comparator coupled to the combining means for comparing the combined dot product result with the common data pattern to generate a comparing result;
and
a processor coupled to the comparator for determining a time from the comparing result.

26. An apparatus as recited in claim 25, further comprising;
a receiver for receiving the at least two signals.

27. An apparatus as recited in claim 25 wherein the correlator further comprises:
means for creating a coherent in-phase and quadrature correlation data, and
means for forming a sample dot product from the coherent in-phase and quadrature correlation data.

28. An apparatus as recited in claim 25 further comprising;
a dot product buffer coupled to the correlator for combining and storing the calculated dot product for each of the at least two received signals.

29. An apparatus as recited in claim 28, further comprising:
a data change buffer for storing a data change; and
a second correlator coupled between the data change buffer and the dot product buffer for correlating the combined dot product with the data change.
